(19) United States
(12) Patent Application Publication
(10) Pub. No.: US 2007/0214224 A1
(43) Pub. Date: Sep. 13, 2007

(54) System and method for transmitting cyber threat information in real time

(76) Inventors: Dong Su Nam, Seoul (KR); Dohoon Lee, Yuseong-Gu (KR); Eungki Park, Seo-Gu (KR)

Correspondence Address: LADAS & PARRY LLP, 224 SOUTH MICHIGAN AVENUE, SUITE 1600, CHICAGO, IL, 60604, US

(21) Appl. No.: 11/487,871

(22) Filed: Jul. 17, 2006

(30) Foreign Application Priority Data
Mar. 13, 2006 (KR) 2006-23064

(51) Int. Cl. G06F 15/16

(52) U.S. Cl. 709/206; 709/223

(57) ABSTRACT

A system and method for transmitting cyber threat information in real time, which is designed to minimize overload of a server in order to support large-scale clients, is disclosed. Important related information such as countermeasures against cyber threats or cyber attacks is transmitted in real time to a user through diverse methods including an SMS message, an email message, and a popup message, and thus the user can cope with such cyber threats effectively, actively, and promptly, so that the damage due to the cyber threats against important systems and services can be minimized.

### BACKGROUND OF THE INVENTION

1. Field of the Invention

The present invention relates to a system and method for transmitting cyber threat information in real time, and more particularly to a system and method for transmitting cyber threat information in real time, which can prevent damage due to cyber attacks by promptly transferring important related information such as countermeasures against diverse types of cyber threats or cyber attacks such as worm•virus, denial-of-service attack, hacking, and others, to a person in charge of security in real time.

2. Background of the Related Art

Recently, with the rapid growth of information and communication technologies, ubiquitous environments, in which computers and Internet can be freely used, have been acceleratively realized, and the degree of dependence on cyber spaces has been heightened in the fields of politics, economics, society, and culture. Due to this, threats in a cyber space have been evolved into diverse forms such as malicious code attack such as bot series worm and spyware including traditional worm•virus, phishing for making fraudulent use of personal financial information to violate to cause property damage, denial-of-service attack on a specified server, and others. However, most defensive means are managers' passive countermeasures such as system security patch, network interception, and others.

Since such a malicious code attack or hacking attack is delivered very quickly, it may cause a high possibility that severe damage has already occurred to cope with the attack after the recognition of the attack. Accordingly, in order to minimize the damage, it is very important to apply a security patch before such attach is delivered or for a manager to cope with the attack in advance. In other words, it is most effective to take preventive measures against the attack through a prompt transmission of the corresponding countermeasures, and thus a prompt security information transfer function is becoming still more important.

Currently, as representative examples of real-time information transfer service, there are a service for notifying the result of settlement through an automatic bank transfer or electronic commerce by an SMS message or email, and a service for providing a popup message in the case of a vaccine program or the like that requires a continuous updating.

However, most notification services as described above function in dependent on specified software or financial services, and no system that independently provides a real-time transfer of cyber threat information has been proposed.

### SUMMARY OF THE INVENTION

Accordingly, the present invention is directed to a system and method for transmitting cyber threat information in real time, which substantially obviates one or more problems due to limitations and disadvantages of the related art.

It is an object of the present invention to provide a system and method for transmitting cyber threat information in real time, which can prevent damage due to cyber attacks through a security manager's putting up of important security information such as countermeasures against diverse types of cyber threats or cyber attacks such as worm•virus, denial-of-service attack, hacking, and others, on a home page, and his/her prompt transferring of the security information to users in real time by using plural methods including SMS messages, email messages, and popup messages.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In order to achieve the above object, there is provided a system for transmitting cyber threat information in real time, according to the present invention, which includes a manager authentication and session management module for granting an authentication and session to a cyber threat information manager so that the cyber threat information manager can freely connect through a wire/wireless communication network; a notice management module for creating a notice so that the manager can perform registration, correction, deletion, and file attachment of the notice, and deciding a subject of real-time transmission of cyber threat information and a transmission method; a user management module capable of managing user's private information registered through an entrance for membership and a transmission history, and designating specified users as a group; a database (DB) input/output module for processing corresponding data to cope with a request for a DB input/output of the new notice, the subject of transmission, and the transmission method; an SMS transmission module for transferring a new message to an SMS server when the cyber threat information manager registers the new message on a notice board, and transmitting an SMS message to a registered user; an email transmission module for transferring the new message to an email server when the cyber threat information manager registers the new message on the notice board, and transmitting an email message to the registered user; a popup transmission module for inquiring a latest message confirmation time of a registered user in order to transfer the new massage in the form of a popup message when the cyber threat information manager registers the new message on the notice board, binding the corresponding message in an XML (Extensive Markup Language) by comparing the user's message confirmation time with a user's preset time, and returning the corresponding message; and a popup reception module for confirming whether the message returned from the pop transmission module is a previously received message, and if the returned message is the new message, displaying the new message to the user in the form of a popup message.

In another aspect of the present invention, there is provided a method for transmitting cyber threat information in real time, which includes the steps of a) registering a manager authentication and a new notice; b) selecting a subject of transmission and a transmission method (e.g., SMS, email, or popup message); c) if the new registered notice is to be transmitted by SMS, selecting a subject of reception through its mobile phone number, connecting to an SMS server, and transferring the phone number subject to reception and a transmitted message to the SMS server; d) if the new registered notice is to be transmitted by email, selecting a subject of reception through its email address, and transferring the subject of transmission, the title and contents of the email to an email server in the form of an SMTP (Simple Mail Transfer Protocol); e) if the new registered notice corresponds to the popup message, comparing a latest massage confirmation time with a validity time set by a user, and if the latest message confirmation time is within the validity time, binding all messages for the corresponding time in an XML (Extensive Markup Language) and returning the transmitted message, while if the latest message confirmation time is not within the validity time, binding only the latest message in the XML and returning the transmitted message; and f) periodically inquiring of a server whether a new message exists according to a period set by the user, receiving the corresponding message in the XML if the new message exists, and displaying the message as the popup message.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating the entire construction of a real-time cyber threat information transmission system according to an embodiment of the present invention;

FIG. 2 is a flowchart illustrating a process performed by an SMS transmission module according to an embodiment of the present invention;

FIG. 3 is a flowchart illustrating a process performed by an email transmission module according to an embodiment of the present invention;

FIG. 4 is a flowchart illustrating a process performed by a popup transmission module according to an embodiment of the present invention; and

FIG. 5 is a flowchart illustrating a process performed by a popup reception module according to an embodiment of the present invention.

### DETAILED DESCRIPTION OF THE PREFERRED EMBODIMENT

A system and method for transmitting cyber threat information in real time according to the preferred embodiment of the present invention will now be explained in detail with reference to the accompanying drawings.

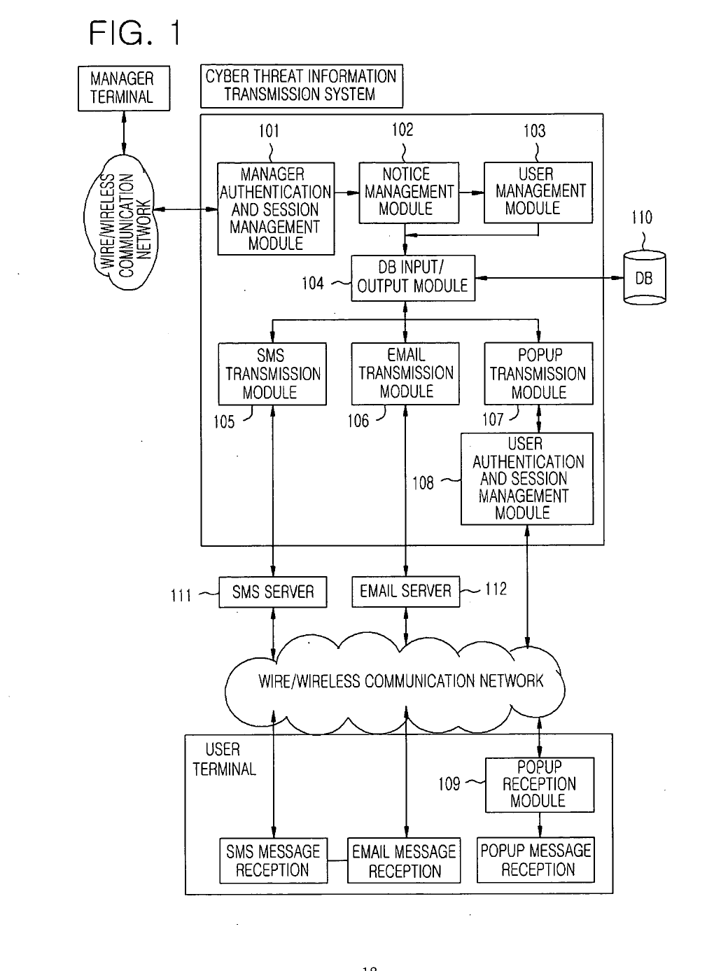

FIG. 1 is a block diagram illustrating the entire construction of a real-time cyber threat information transmission system according to an embodiment of the present invention.

As illustrated in FIG. 1, the system for transmitting cyber threat information in real time according to an embodiment of the present invention includes a manager authentication and session management module 101, a notice management module 102, a user management module 103, a database (DB) input/output module 104, an SMS (Short Message Service) transmission module 105, an email transmission module 106, a popup transmission module 107, a user authentication and session management module 108, and a popup reception module 109. The system further includes a DB 110 that interworks with the DB input/output module 104.

The manager authentication and session management module 101 compares a password input by a manager for login with a password stored in the DB 110, and if they coincide with each other, it creates a manager authority session and returns a success XML, while if they do not coincide with each other, it just returns a failure XML. If no communication is performed for 30 minutes after the connection is completed, the session expires and a logout process is performed.

After the manager passes through the authentication process, the notice management module 102 serves to access a notice board, prepare new information as a notice, and select a subject of transmission and a transmission method. The notice management module also performs registration, correction, deletion, and file attachment of the notice.

The notice management module 102 manages the entrance and withdrawal of a membership, a user's SMS message transmission history, an email message transmission history, and a popup message transmission history, and performs a grouping of users to heighten the message transmission efficiency.

The DB input/output module 104 forms all functions related to DB accesses such as input, correction, deletion, and inquiry about information in the DB 110.

The SMS transmission module 105 inquires of the DB input/output module 104 about a mobile phone number of a subject of transmission for a new notice, and if the subject of transmission exists, the SMS transmission module connects to an SMS server 111, and transfers the mobile phone number of the subject of transmission and an SMS message to be transmitted to the SMS server 111. In this case, the SMS server 111 transfers text to the user's mobile phone through a base station.

The email transmission module 106 inquires of the DB input/output module 104 about an email address of a subject of transmission for a new notice, and if the subject of transmission exists, it prepares the title and contents of an email and transfers the email to an email server 112. In this case, the email server 112 transfers the email to the user's email address through a communication network.

The popup transmission module 107 gives the session through the authentication process of the user authentication and session management module 108, and inquires of the DB input/output module 104 about the latest message confirmation time of the corresponding user. Then, the popup transmission module decides a message to be transmitted by comparing the latest message confirmation time with the validity time, updates the message confirmation time in a user table, and binds the notice in the XML to return the corresponding notice.

The user authentication and session management module 108 compares an ID and a password input by the user for login with an ID and a password stored in the DB 110, and if they coincide with each other, it creates a user authority session and returns a success XML, while if they do not coincide with each other, it just returns a failure XML. If no communication is performed for 30 minutes after the connection is completed, the session expires and a logout process is performed.

The popup reception module 109 inquired of the user authentication and session management module 108 whether a new notice exists according to a period set by the user, and if a popup message is transmitted from the popup transmission module 107, it receives and displays the popup message on the user's computer in the form of a popup message.

As described above, since the system for transmitting cyber threat information in real time according to the present invention is developed in an independent program language being stored in an OS platform, it is operable irrespective of the OS system such as Windows or Unix, and has a structure that can be used in a web server based Internet or private network. The system is additionally provided with the email transmission server 112 and the SMS server 111.

When important security information occurs, the manager of the real-time cyber threat information transmission system according to the present invention prepares it on the notice board, designates the subject of transmission and the transmission method (e.g., SMS message, email message or popup message), and registers the notice. In this case, the corresponding information is stored in the DB 110 by the DB input/output module 104. The SMS transmission module 105, the email transmission module 106, and the popup transmission module 107 periodically inquire of the DB input/output module 104 whether a new notice exists, and if the new notice exists, it gets the subject of transmission and the message to be transmitted from the DB input/output module 104, and transmits the corresponding information to the SMS server 111, the email server 112, and the popup reception module 109.

The SMS transmission module 105 brings the mobile phone number of the subject of transmission, performs a connection process with the SMS server 111, and transfers the SMS message to the SMS server 111. The SMS transmission module performs history management of the transmission result by storing the result of transmission in the DB 110, and thus it makes it possible to perform a retransmission when the transmission has failed.

The email transmission module 106 brings the email address of the subject of transmission, prepares the title and contents of an email, and transmits the email to the email server 112. The email transmission module performs history management of the result of transmission by storing the result of transmission in the DB 110, and thus it makes it possible to perform a retransmission when the transmission has failed.

If a request for confirming whether a new message exists is received from the popup reception module 109, the popup transmission module 107 inquires the latest message confirmation time of the corresponding user by using an email address, and compares the latest message confirmation time with the validity time set by the user. If the latest message confirmation time is within the validity time, the popup transmission module indicates all messages in a transmission result field of the DB table, while if the latest message confirmation time is not within the validity time, it indicates the one latest message in the transmission result field of the DB table, binds the corresponding notice in the XML, and returns the corresponding notice.

The popup reception module 109 is provided in a user computer, and inquires of the popup transmission module 107 whether a new notice exists. If the new notice exists, the popup reception module gets and displays the new message on the user's computer in the form of a popup message.

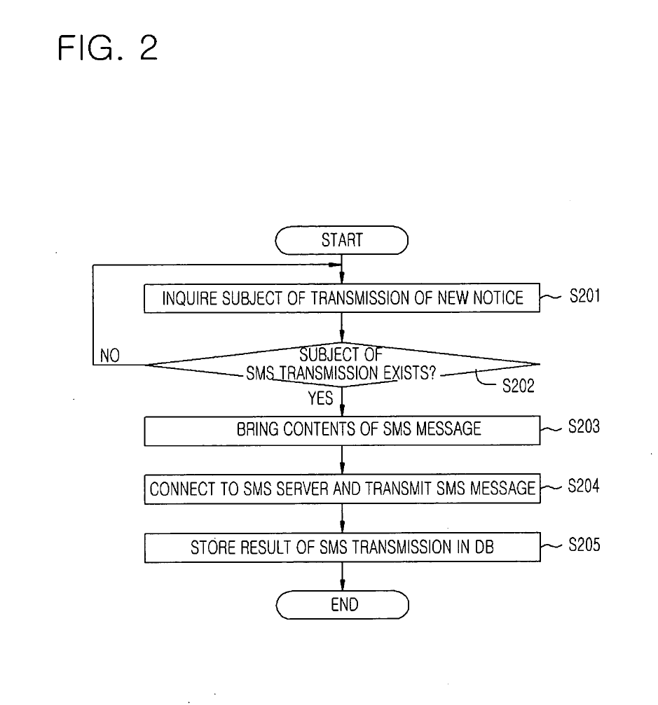

Now, the method for transmitting cyber threat information in real time, which is performed by the apparatus as constructed above, will be explained with reference to FIGS. 2 to 5.

FIG. 2 is a flowchart illustrating a process performed by an SMS transmission module according to an embodiment of the present invention.

As illustrated in FIG. 2, the SMS transmission module 105 inquires the subject of transmission for a new notice (S201), and if the subject of SMS transmission exists (S202), it receives an SMS message to be transmitted from the DB input/output module 104 (S203). Also, the SMS transmission module connects to the SMS server 111, transmits the SMS message to the SMS server 111 (S204), and stores the result of SMS message transmission in the DB 110 (S205).

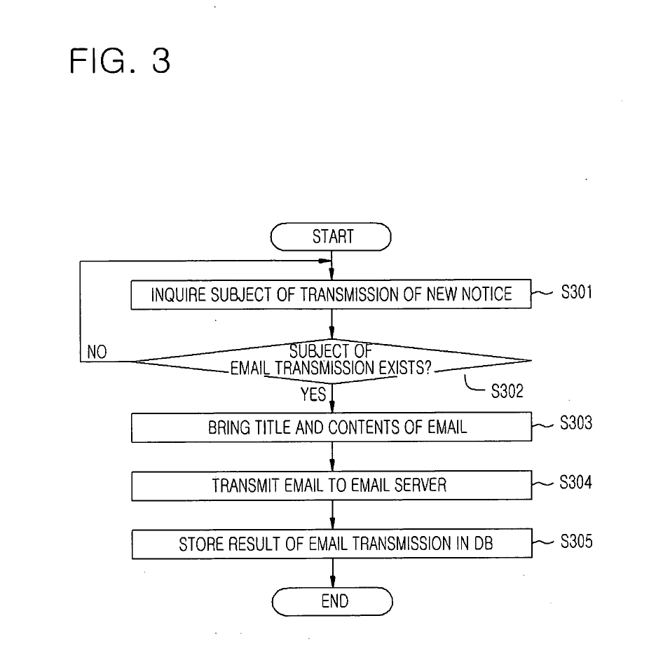

FIG. 3 is a flowchart illustrating a process performed by an email transmission module according to an embodiment of the present invention.

As illustrated in FIG. 3, the email transmission module 106 inquires the subject of transmission for a new notice (S301), and if the subject of email transmission exists (S302), it receives the title and contents of an email to be transmitted from the DB input/output module 104 (S303). Also, the email transmission module transmits the email to the email server 112 (S304), and stores the result of email transmission in the DB 110 (S305).

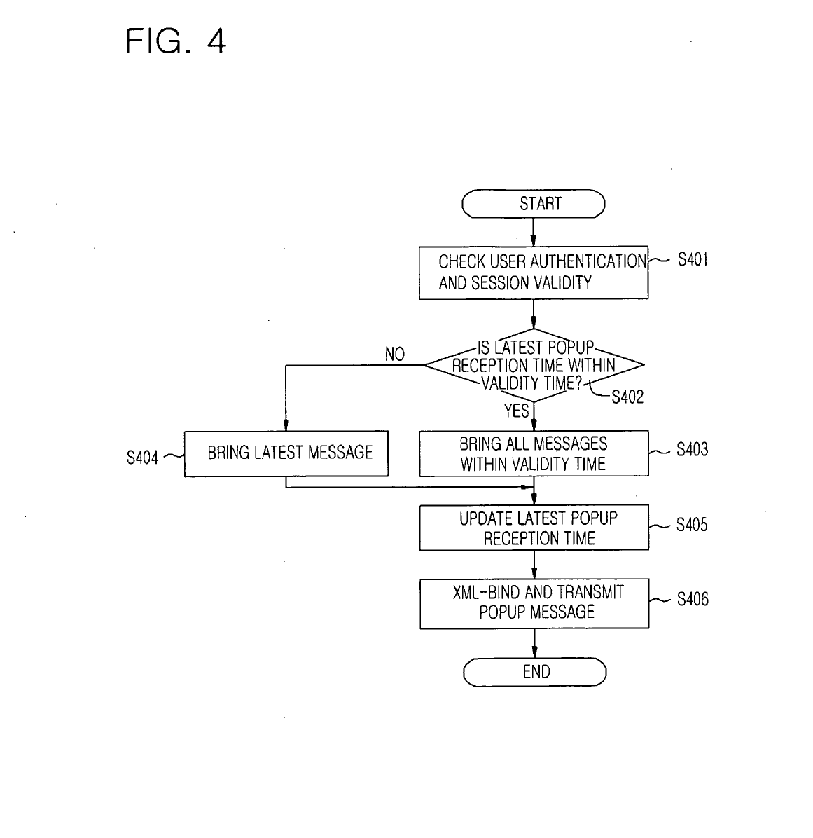

FIG. 4 is a flowchart illustrating a process performed by a popup transmission module according to an embodiment of the present invention.

As illustrated in FIG. 4, the popup transmission module 107 checks the user authentication and session validity (S401), and compares the user's latest popup reception time with the validity time set by the user (S402). If the latest reception time is within the validity time, the popup transmission module brings all messaged in the validity time (S403), while if the latest reception time is not within the validity time, it brings only the latest message (S404). The popup transmission module updates the latest popup reception time in the DB 110 (S405), binds the popup message in the form of an XML, and transmits the XML popup message to the user (S406).

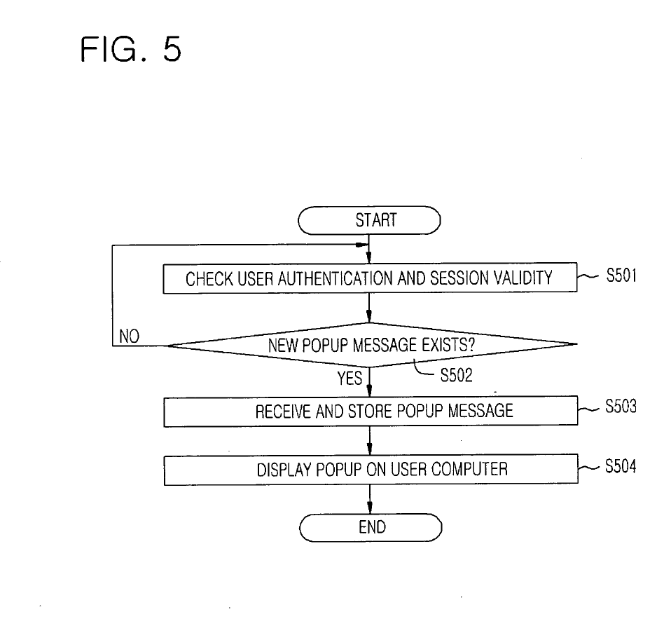

FIG. 5 is a flowchart illustrating a process performed by a popup reception module according to an embodiment of the present invention.

As illustrated in FIG. 5, the popup reception module 109 checks the user authentication and session validity (S501), and if a new popup message exists (S502), it receives the popup message from the popup transmission module 107 (S503), stores the popup message in a data structure, and displays the popup message on the user's computer (S504).

In the embodiment of the present invention, the user can instantly receive the cyber threat information by simultaneously receiving the cyber thread information in three ways (e.g., through the SMS message, email message, and popup message).

As described above, according to the present invention, the cyber thread information is transferred to the user in three ways (e.g., through the SMS message, email message, and popup message), and thus the user can instantly cope with the cyber threats, so that the damage due to the worm•virus, hacking, and others, can be prevented in advance or minimized. Also, since the cyber threat information transmission system is constructed by an independent web-based program in an OS platform, it is easy to install the system, and both the manager and the user can access and use the system through any computer connected to the wire/wireless communication network.

In addition, even if the user is out when cyber thread information, on which an instant countermeasure is required, occurs, the corresponding information can be confirmed in real time through an SMS message, while if the user is using a computer, the corresponding information can be displayed as a popup message, so that the probability of transferring information to the user can be heightened. Further, after the validity time set by the user, only the latest message is transmitted to the user, and thus the load of the cyber threat information transmission system can be reduced.

While the system and method for transmitting cyber thread information in real time according to the present invention has been described and illustrated herein with reference to the preferred embodiment thereof, it will be understood by those skilled in the art that various changes and modifications may be made to the invention without departing from the spirit and scope of the invention, which is defined in the appended claims.

What is claimed is:

1. A system for transmitting cyber threat information in real time, comprising:
a manager authentication and session management module for granting an authentication and session to a manager terminal that manages security information including countermeasures on cyber threats or cyber attacks;
a notice management module for creating a new notice so that the management terminal can perform registration, correction, deletion, and file attachment of the new notice, and deciding a subject of real-time transmission of cyber threat information and a transmission method selected among an SMS (Short Message Service), an email, and a popup;
a user management module capable of managing user's private information and a transmission history, and designating specified users as a group;
a database (DB) input/output module for processing corresponding data to cope with a DB input/output request for the new notice, the subject of transmission, and the transmission method; and
a transmission module for transmitting the new notice according to the selected transmission method if the new notice is registered

2. The system as claimed in claim 1, wherein the transmission module is an SMS transmission module that transfers the new notice in the form of an SMS message when the manager terminal registers the new notice.

3. The system as claimed in claim 2, wherein the SMS message is transferred to a user terminal via an SMS server.

4. The system as claimed in claim 1, wherein the transmission module is an email transmission module that transfers the new notice in the form of an email message when the manager terminal registers the new notice.

5. The system as claimed in claim 4, wherein the email message is transferred to a user terminal via an email server.

6. The system as claimed in claim 1, wherein the transmission module is a popup transmission module that inquires a user's latest message confirmation time when the manager terminal registers the new notice, binds the corresponding new notice in an XML (Extensive Markup Language) by comparing the latest message confirmation time with a time set by the user, and returns the notice.

7. The system as claimed in claim 6, wherein the popup message is transferred to the popup transmission module via a user authentication and session management module which performs an authentication of an ID and a password input by the user for login, creates a user authority session and returns a success XML (Extensive Markup Language) if the authentication succeeds, and returns a failure XML only if the authentication fails.

8. A method for transmitting cyber threat information in real time, comprising the steps of:
a) a real-time cyber threat information transmission system performing an authentication of a manager terminal that manages security information including countermeasures on cyber threats or cyber attacks, and registering a new notice;
b) the real-time cyber threat information transmission system selecting a subject of transmission and a transmission method selected among an SMS (Short Message Service), an email, and a popup, in association with a database; and
c) transmitting the new notice to a corresponding transmission module according to the selected transmission method.

9. The method as claimed in claim 8, wherein if the new notice corresponds to an SMS message, a subject of reception is selected through its mobile phone number, and the mobile phone number of the subject of transmission and the message are transferred to a connected SMS server.

10. The method as claimed in claim 8, wherein if the new notice corresponds to an email, a subject of reception is selected through an email address, and the subject of transmission, a title and contents of the email are transferred to an email server in the form of an SMTP (Simple Mail Transfer protocol)

11. The method as claimed in claim 8, wherein if the new notice corresponds to a popup message, a latest message confirmation time is compared with a validity time set by a user, and if the latest message confirmation time is within the validity time, all messages for the corresponding time are bound in an XML (Extensive Markup Language) and the transmitted message is returned, while if the latest message confirmation time is not within the validity time, only a latest message is bound and the transmitted message is returned.

12. The method as claimed in any one of claims 8 to 11, further comprising the step of periodically inquiring of the real-time cyber threat information transmission system whether a new notice exists according to a period set by the user, and if the new notice exists, receiving the corresponding message in the XML, and displaying the message as a popup message.
